(19) United States
(12) Patent Application Publication
(10) Pub. No.: US 2023/0055597 A1
(43) Pub. Date: Feb. 23, 2023

(54) System, Method, Program and Recording Medium Recording Program for Recommendation Item Determination and Personality Model Generation

(71) Applicant: Umee Technologies Inc., Tokyo (JP)

(72) Inventors: Hirotaka Niiro, Tokyo (JP); Atsushi Nakajima, Chiba-shi, Chiba (JP); Shuichi Hirai, Sagamihara-shi, Kanagawa (JP)

(21) Appl. No.: 17/757,993

(22) PCT Filed: Dec. 27, 2019
(86) PCT No.: PCT/JP2019/051586

§ 371 Date: Jun. 24, 2022

(51) Int. Cl. G06Q 30/06; G10L 25/63; G10L 15/22; G10L 15/18

(52) U.S. Cl. CPC G06Q 30/0631; G10L 15/22; G10L 15/1815; G10L 25/63

(57) ABSTRACT

A recommendation item determination system is configured to: compute an emotion index of a user based on a voice signal acquired from a conversation between the user and a conversational partner of the user, compute a personality element index based on a speech text generated by voice recognition on the voice signal of the user; generate a first personality model of the user based on the emotional index and the personality element index, compute, respectively for a plurality of personality types, personality type similarities each of which is a similarity between the first personality model of the user and the first personality model of the personality type; generate a second personality model of the user based on the plurality of personality type similarities; extract one or more items from a group of items represented by the second personality model; and determine a recommendation item based on the extracted one or more items.

### TECHNICAL FIELD

The present invention relates to a system, a method, a program, and a recording medium recording the program for recommendation item determination and personality model generation.

### BACKGROUND ART

In services that recommend products, services, content, people, and other items, collaborative filtering techniques are often used to extract appropriate recommendation items. The collaborative filtering recommends items purchased or utilized by other users similar to a user (e.g., see Patent Literature 1 below).

### Citation List

### Patent Literature

Patent Literature 1: Japanese Unexamined Patent Application Publication 2008-225629

### SUMMARY OF INVENTION

### Technical Problem

However, because the cooperative filtering recommends items purchased or utilized by other users similar to a user for whom that an item is recommended, accurate item recommendation is difficult without a certain amount of accumulated data of a user’s action history such as a purchase history or a usage history. The user’s action history is increasingly accumulated in a case of services on the internet, but in a case of an item for which the user’s action history is difficult to accumulate from its nature, such as a made-to-order product, for example, the item recommendation is inherently difficult.

In the cooperative filtering, because a recommendation item is automatically determined without human intervention, the reason why the item is recommended is unknown and it is difficult to, for example, make an adjustment to precisely recommend the item for users as targets of the item.

The more parameters used to determine a recommendation item, the more precisely the recommendation can be made, but, for example, it is difficult to make an adjustment to precisely recommend the item for users as targets of the item.

As such, one of objects of the present invention is to provide a system, a method, a program, and a recording medium recording the program capable of item recommendation even without accumulated data of a user’s action history.

One of objects of the present invention is to provide a system, a method, a program, and a recording medium recording the program capable of facilitating grasp of a reason why an item is recommended and facilitating an adjustment to precisely recommend the item for users as targets of the item.

As an example, one of objects of the present invention is to provide a system, a method, a program, and a recording medium recording the program for generating a personality model that can be used for the above-described system, method, program, and recording medium recording the program.

### Solution to Problem

One aspect of the present invention may provide a recommendation item determination system including an emotion index computation unit configured to compute an emotion index of a user based on a voice signal acquired from a conversation between the user and a conversational partner of the user, a personality element index computation unit configured to compute a personality element index based on a speech text generated by voice recognition on the voice signal of the user, a first personality model generation unit configured to generate, based on the emotion index and the personality element index, a first personality model of the user based on an emotion index and a personality element index, a first personality model similarity computation unit configured to compute, respectively for a plurality of personality types, personality type similarities each of which is a similarity between the first personality model of the user and the first personality model of the personality type, a second personality model generation unit configured to generate, based on the plurality of personality type similarities, a second personality model of the user based on a personality type similarity, an item extraction unit configured to extract one or more items from a group of items represented by the second personality model, and a recommendation item determination unit configured to determine a recommendation item based on the extracted one or more items.

The recommendation item determination system may further include a setting unit configured to set and/or change a value of the emotion index and/or the personality element index of the first personality model of at least one personality type of the plurality of personality types, and/or at least one of personality type similarities of the second personality type of at least one item of the group of items.

The recommendation item determination system may further includes a topic model generation unit configured to generate a topic model of the user representing a relevance degree for each of a plurality of topics based on the voice signal of the user or the speech text of the user, and a topic similarity computation unit configured to compute, for each of the extracted items, a topic similarity that is a similarity between a topic model of the user and a topic model of the item, wherein the recommendation item determination unit may be configured to determine a recommendation item based on the plurality of computed topic similarities.

The setting unit may further be configured to set and/or change a value of at least one of elements of the topic model of the items.

The item extraction unit may be configured to extract, from a group of items represented by the second personality models, an item represented by the second personality model whose primary component corresponds to a personality type corresponding to a primary component of the second personality model of the user.

The recommendation item determination system may further include a second personality model similarity computation unit configured to compute a second personality model similarity that is a similarity between the second personality model of the user and the second personality model of the item for each item in the group of items represented by the second personality models, wherein the item extraction unit may be configured to extract one or more items from the group of items based on the plurality of computed second personality model similarities.

The recommendation item determination system may further include a second personality model similarity computation unit configured to compute a second personality model similarity that is a similarity between the second personality model of the user and the second personality model of the item for each item in the group of items represented by the second personality models, wherein the item extraction unit may include a primary component-based item extraction unit and a similarity-based item extraction unit, the primary component-based item extraction unit may extract, from the group of items represented by the second personality models, the item represented by the second personality model whose primary component corresponds to a personality type corresponding to a primary component of the second personality model of the user, the similarity item extraction unit may be configured to extract one or more items from the group of items based on the plurality of computed second personality model similarities, the recommendation item determination unit may be configured to determine a first recommendation item based on the plurality of topic similarities computed by the primary component-based item extraction unit, determine a second recommendation item based on the plurality of topic similarities computed by the similarity item extraction unit, and determine the first recommendation item and the second recommendation item as recommendation items.

The emotion index may include an emotion degree and a reason degree.

The personality element index may include an innovativeness degree and a conservativeness degree.

The first and/or second personality model may be represented by a vector.

The second personality model may have elements of an emotion degree, a reason degree, an innovativeness degree, and a conservativeness degree.

The plurality of personality types may include a type of favoring a new matter or an innovative matter, having great communication skills, being challenging, and having large emotional ups and downs, a type of being conservative, having great communication skills, being conformable, and being emotionally expressive, a type of favoring a new matter or an innovative matter and coolly and comprehensively making a decision, and a type of being conservative and cool, being scrupulous, and favoring stability.

The topic vector of the user may have an element of a numerical value based on the number of times at which at least one keyword preset for each topic appears in the speech text.

One aspect of the present invention may provide a personality model generation system including an emotion index computation unit configured to computean emotion index of a user based on a voice signal acquired from a conversation between the user and a conversational partner of the user, a personality element index computation unit configured to compute a personality element index based on a speech text generated by voice recognition on the voice signal of the user, a first personality model generation unit configured to generate, based on the emotion index and the personality element index, a first personality model of the user based on an emotion index and a personality element index, a first personality model similarity computation unit configured to compute, respectively for a plurality of personality types, personality type similarities each of which is a similarity between the first personality model of the user and the first personality model of the personality type, and a second personality model generation unit configured to generate, based on the plurality of personality type similarities, a second personality model of the user based on a personality type similarity.

The personality model generation system may further include a setting unit configured to set and/or change a value of the emotion index and/or the personality element index of the first personality model of at least one personality type of the plurality of personality types, and/or at least one of personality type similarities of the second personality type of at least one item of the group of items.

The personality model generation system may include an emotion index computation unit configured to compute an emotion index of a user based on a voice signal acquired from a conversation between the user and a conversational partner of the user, a personality element index computation unit configured to compute a personality element index based on a speech text generated by voice recognition on the voice signal of the user, and a first personality model generation unit configured to generate, based on the emotion index and the personality element index, a first personality model of the user based on an emotion index and a personality element index.

One aspect of the present invention may provide a recommendation item determination method executed by a computer, the method including computing an emotion index of a user based on a voice signal acquired from a conversation between the user and a conversational partner of the user, computing a personality element index based on a speech text generated by voice recognition on the voice signal of the user, generating, based on the emotion index and the personality element index, a first personality model of the user based on an emotion index and a personality element index, computing, respectively for a plurality of personality types, personality type similarities each of which is a similarity between the first personality model of the user and the first personality model of the personality type, generating, based on the plurality of personality type similarities, a second personality model of the user based on a personality type similarity, extracting one or more items from a group of items represented by the second personality model, and determining a recommendation item based on the extracted one or more items.

One aspect of the present invention may provide a program causing a computer to execute the method.

One aspect of the present invention may provide computer-readable recording medium in which the program is recorded.

One aspect of the present invention may provide a method of generating a recommendation item determination system by installing the program on the computer.

### Advantageous Effects of Invention

According to the present invention having the above configuration, it is possible to provide a system, a method, and a program capable of item recommendation even without accumulated data of a user’s action history, and a recording medium recording the program.

According to the present invention having the above configuration, it is possible to provide a system, a method, a program, and a recording medium recording the program capable of facilitating grasp of a reason why an item is recommended and facilitating an adjustment to precisely recommend the item for users as targets of the item.

According to the present invention having the above configuration, an example, it is possible to provide a system, a method, a program, and a recording medium recording the program for generating a personality model that can be used for the above-described system, method, program, and recording medium recording the program.

### BRIEF DESCRIPTION OF DRAWINGS

FIG. 1 is a diagram illustrating an overall configuration of a recommendation item determination system according to a first embodiment of the present invention.

FIG. 2 is a diagram illustrating a hardware configuration of the recommendation item determination system according to the first embodiment of the present invention.

FIG. 3 is a schematic flowchart of an example of a recommendation item determination process according to the first embodiment of the present invention.

FIG. 4 is a flowchart of an example of a voice related information acquisition process according to the first embodiment of the present invention.

FIG. 5 is a flowchart of an example of a personality model generation process according to the first embodiment of the present invention.

FIG. 6 shows a personality element keyword list according to the first embodiment of the present invention.

FIG. 7 is a diagram illustrating a first personality model table of a personality type according to the first embodiment of the present invention.

FIG. 8A is a flowchart of an example of a preference model generation and recommendation item determination process according to the first embodiment of the present invention.

FIG. 8B is a flowchart of an example of the preference model generation and recommendation item determination process according to the first embodiment of the present invention.

FIG. 9 shows a second personality model table of a restaurant according to the first embodiment of the present invention.

FIG. 10 shows a topic keyword list according to the first embodiment of the present invention.

FIG. 11 shows a topic model table of a restaurant according to the first embodiment of the present invention.

FIG. 12 is a flowchart illustrating an example of a voice related information acquisition process according to a second embodiment of the present invention.

FIG. 13 is a flowchart of an example of a personality model generation process according to the second embodiment of the present invention.

FIG. 14A is a flowchart of an example of a preference model generation and recommendation item determination process according to the second embodiment of the present invention.

FIG. 14B is a flowchart of an example of the preference model generation and recommendation item determination process according to the second embodiment of the present invention.

FIG. 15 shows a second personality model table of a travel plan according to the second embodiment of the present invention.

FIG. 16 shows a topic keyword list according to the second embodiment of the present invention.

FIG. 17 shows a topic model table of a travel plan according to the second embodiment of the present invention.

### DESCRIPTION OF EMBODIMENTS

Hereinafter, embodiments of the present invention will be described with reference to the drawings.

### First Embodiment

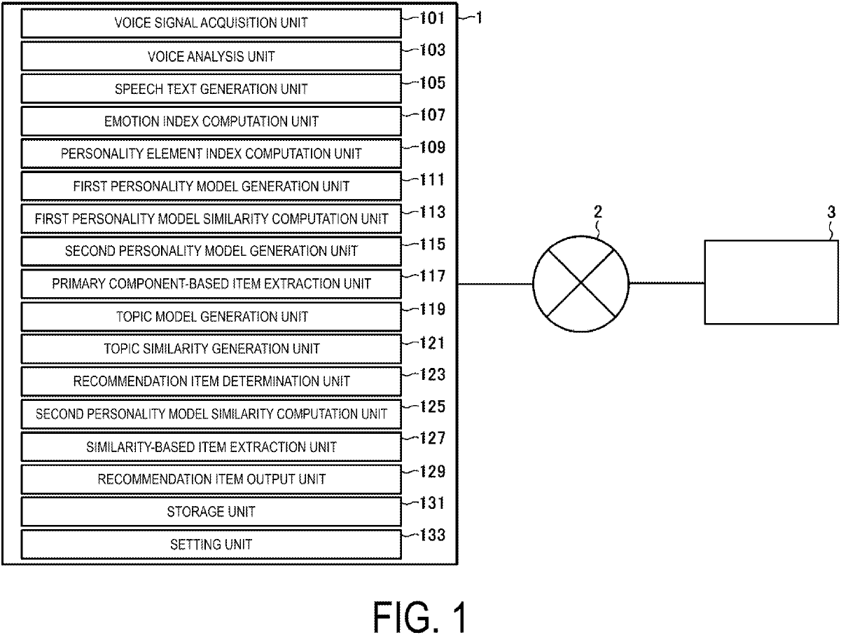

FIG. 1 is a diagram illustrating an overall configuration of a recommendation item determination system according to a first embodiment of the present invention. A recommendation item determination system 1 is connected to a terminal 3 via a network 2. Each of the recommendation item determination system 1 and the terminal 3 needs not be configured as one physical device, but may be composed of a plurality of physical devices.

Examples of the terminal 3 may include any suitable terminal provided with a microphone and having a data communication function, such as a PC, a smartphone, a tablet terminal, and a mobile phone.

The recommendation item determination system 1 includes a voice signal acquisition unit 101, a voice analysis unit 103, a speech text generation unit 105, an emotion index computation unit 107, a personality element index computation unit 109, a first personality model generation unit 111, a first personality model similarity computation unit 113, a second personality model generation unit 115, a primary component-based item extraction unit 117, a topic model generation unit 119, a topic similarity computation unit 121, a recommendation item determination unit 123, a second personality model similarity computation unit 125, a similarity-based item extraction unit 127, a recommendation item output unit 129, a storage unit 131, and a setting unit 133. The recommendation item determination system 1 need not be configured as one physical device, but can be composed of multiple physical devices.

The voice signal acquisition unit 101 acquires a voice signal of conversation between a use and a conversational partner of the user.

The voice analysis unit 103 performs voice analysis of the voice signal of the conversation between the user and the conversational partner of the user acquired by the voice signal acquisition unit 101 and detects speech durations and perform a speaker identification, and thereby, identifies a speech duration of the user and a speech duration of the conversational partner of the user.

The speech text generation unit 105 performs voice recognition on the voice signal for the identified speech duration of the guest to generate a speech text.

The emotion index computation unit 107 computes an emotion index of the user based on the voice signal of the user acquired from the conversation between the user and the conversational partner of the user.

The personality element index computation unit 109 computes a personality element index based on the speech text generated by the voice recognition on the voice signal of the user.

The first personality model generation unit 111 generates a first personality model of the user based on the emotion index and the personality element index based on the computed emotion index and the personality element index.

The first personality model similarity computation unit 113 computes, respectively for a plurality of personality types, personality type similarities each of which is a similarity between the first personality model of the user and the first personality model of the personality type.

The second personality model generation unit 115 generates a second personality model of the user based on the personality type similarity based on the plurality of computed personality type similarities.

The primary component-based item extraction unit 117 extracts, from a group of items represented by the second personality models, the item represented by the second personality model whose primary component corresponds to a personality type corresponding to a primary component of the second personality model of the user. The primary component-based item extraction unit 117 and the similarity-based item extraction unit 127 described below correspond to an item extraction unit.

The topic model generation unit 119 generates a topic model representing a relevance degree of the user for each of a plurality of topics based on the voice signal of the user or the speech text of the user.

The topic similarity computation unit 121 computes, for each of the extracted items, a topic similarity that is a similarity between a topic model of the user and a topic model of the item.

The recommendation item determination unit 123 determines a recommendation item based on one or more items extracted by the primary component-based item extraction unit 117 and/or the similarity-based item extraction unit 127 described below.

The second personality model similarity computation unit 125 computes a second personality model similarity that is a similarity between the second personality model of the user and the second personality model of the item for each item in the group of items represented by the second personality models.

The similarity-based item extraction unit 127 extracts one or more items from the group of items based on the plurality of computed second personality model similarities.

The recommendation item output unit 129 outputs a first recommendation restaurant and/or a second recommendation restaurant stored in the storage unit 131 by transmission to the terminal 3, display on a display, voice, or the like.

The storage unit 131 stores various types of information. The storage unit 131 may be configured as one physical device or dispersedly located as a plurality of physical devices.

The setting unit 133 sets or changes, by input from an operator or the like, a keyword stored in a personality element keyword list 501 of the storage unit 131, values of an emotion index and a personality element index stored in a first personality model table 503 for personality types, a personality type similarity stored in a second personality model table 505 for a group of restaurants, a keyword stored in a topic keyword list 507, a value of an element of a topic model stored in a topic model table 509 for a group of restaurants, a personality type similarity stored in a second personality model table 605 for a group of travel plans, a keyword stored in a topic keyword list, a value of an element of a topic model stored in a topic model table 609 for a group of travel plans, and the like.

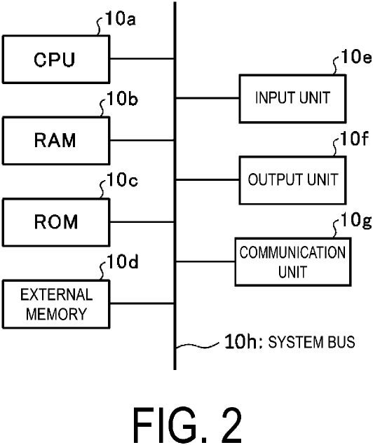

FIG. 2 is a diagram illustrating a hardware configuration of the recommendation item determination system according to the first embodiment of the present invention. The recommendation item determination system 1 includes a CPU 10a, a RAM 10b, a ROM 10c, an external memory 10d, an input unit 10e, an output unit 10f, and a communication unit 10g. The RAM 10b, the ROM 10c, the external memory 10d, the input unit 10e, the output unit 10f, and the communication unit 10g are connected to the CPU 10a via a system bus 10h.

The CPU 10a comprehensively controls each device connected to the system bus 10h.

In the ROM 10c and the external memory 10d, stored are a BIOS or an OS that is a control program for the CPU 10a, and various programs, data, and the like necessary for realizing functions executed by a computer.

The RAM 10b functions as a main memory, a workspace, and the like for the CPU. The CPU 10a implements various operations by loading the program or the like necessary for executing processing from the ROM 10c and the external memory 10d to execute the loaded program.

The external memory 10d includes a flash memory, a hard disk, a DVD-RAM, a USB memory, and the like, for example.

The input unit 10e receives an operation instruction from a user or the like and the like. The input unit 10e includes an input device such as an input button, a keyboard, a pointing device, a wireless remote, a microphone, and a camera.

The output unit 10f outputs data processed by the CPU 10a, and data stored in the RAM 10b, the ROM 10c, and the external memory 10d. The output unit 10f includes an output device such as a CRT display, an LCD, an organic EL panel, a printer, and a speaker, for example.

The communication unit 10g is an interface for connecting and communicating with an external equipment via a network or directly. The communication unit 10g includes an interface such as a serial interface and a LAN interface.

The respective units of the article management system 1 are realized by the various programs stored in the ROM and the external memory using the CPU, the RAM, the ROM, the external memory, the input unit, the output unit, the communication unit, and the like as sources.

Given the above system configuration, examples of a recommendation item determination process for the recommendation item determination system according to the first embodiment of the present invention will be described below with reference to FIGS. 1 to 11 and the like.

In the present embodiment, a case that a guest as a user asks a front desk clerk for a restaurant recommendation at a front desk of a hotel is described as an example.

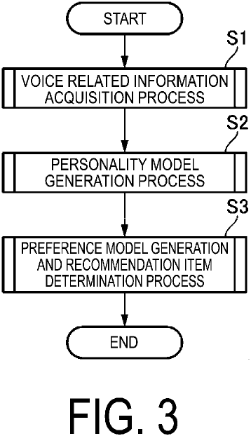

FIG. 3 is a schematic flowchart of an example of the recommendation item determination process according to the first embodiment of the present invention. The recommendation item determination process of the recommendation item determination system according to the first embodiment of the present invention includes a voice related information acquisition process (S1), a personality model generation process (S2), a preference model generation and recommendation item determination process (S3). Hereinafter, each of the processes will be described in detail.

### Voice Related Information Acquisition Process

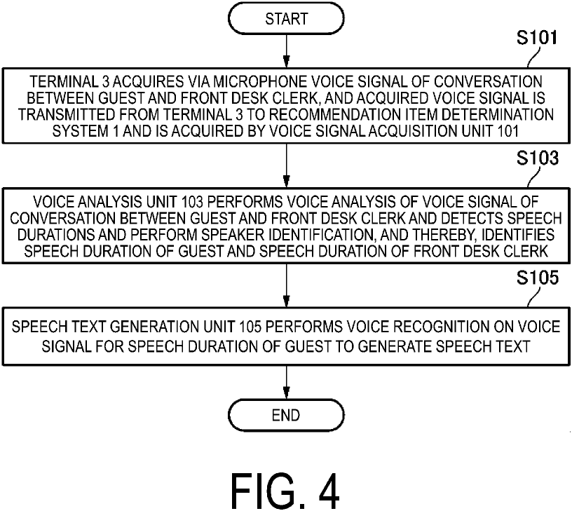

FIG. 4 is a flowchart of an example of the voice related information acquisition process according to the first embodiment of the present invention.

The terminal 3 located at the front desk of the hotel acquires via a microphone (not illustrated) a voice signal of a conversation between the guest and the front desk clerk, and the acquired voice signal is transmitted from the terminal 3 to the recommendation item determination system 1 and is acquired by the voice signal acquisition unit 101 (S101). The voice signal acquired by the voice signal acquisition unit 101 is not limited to the above, but may be voice signals of conversations between any other suitable user and any number of conversational partners of the user.

In the present embodiment, a case that the conversation between the guest and the front desk clerk of the voice signal transmitted from the terminal 3 to the recommendation item determination system 1 is like the following is described as an example. Guest: I am looking for a restaurant for dinner today. Front desk clerk: What kind of restaurant do you prefer? Guest: Japanese-style or Thai food. Front desk clerk: What kind of taste do you prefer? Guest: I prefer a food with originality I don’t usually eat because I am coming here on the trip. A cilantro or nam-pla dish or the like may be preferable. A famous restaurant may be also preferable if any.

The voice analysis unit 103 performs voice analysis of the voice signal of the conversation between the guest and the front desk clerk acquired by the voice signal acquisition unit 101 and detects speech durations and perform a speaker identification, and thereby, identifies a speech duration of the guest and a speech duration of the front desk clerk (S103).

The speech text generation unit 105 performs voice recognition on the voice signal for the speech duration of the guest identified in S103 to generate a speech text (S105).

### Personality Model Generation Process

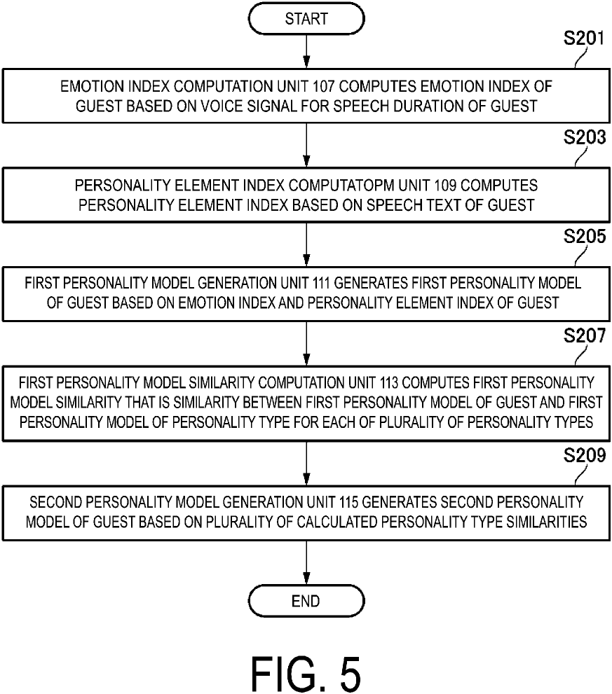

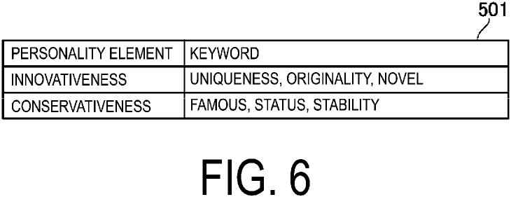

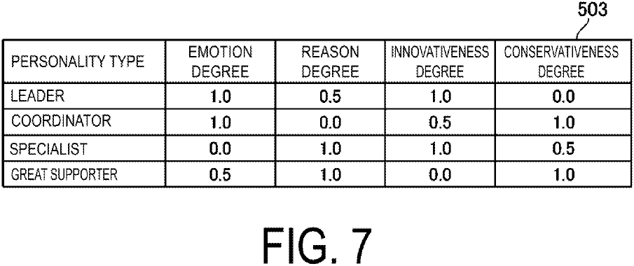

FIG. 5 is a flowchart of an example of the personality model generation process according to the first embodiment of the present invention. FIG. 6 shows a personality element keyword list according to the first embodiment of the present invention. FIG. 7 is a diagram illustrating a first personality model table of a personality type according to the first embodiment of the present invention.

The emotion index computation unit 107 computes an emotion index of the guest based on the voice signal for the speech duration of the guest identified in S103 (S201). Specifically, a vector having an emotion degree and a reason degree as its elements is computed based on a height, strength, intonation, and the like of the voice. In the present embodiment, based on the voice signal for the speech duration of the guest in the above conversation, an emotion index of the guest as a vector having the emotion degree of 0.6 and the reason degree of 0.4, or a vector (0.6, 0.4), is computed. Here, the emotion degree is an index indicating a degree of largeness of a motion of emotion, and the reason degree is an index indicating a degree of smallness of the motion of emotion. The emotion index is not limited to the above, but may be any other suitable index for emotion, and may be an index represented by any other suitable representation such as a scalar quantity, a three or more-dimensional vector, and a matrix.

The personality element index computation unit 109 computes a personality element index based on the speech text of the guest generated in step S107 (S203). Specifically, the personality element index is computed as below.

The storage unit 131 stores therein the personality element keyword list 501, illustrated in FIG. 6, that is a list of keywords indicating personality elements for each of the personality elements constituting personality of a speaker. In the present embodiment, the personality element keyword list 501 including a list of keywords indicating innovativeness of the speaker and a list of keywords that indicate a conservativeness of the speaker is stored. The personality element index computation unit 109 refers to the personality element keyword list 501 to count the number of innovativeness keywords and the number of conservativeness keywords in the speech text of the guest, and computes a vector having an innovativeness degree and a conservativeness degree as its elements, the innovativeness degree being a ratio of the innovativeness keywords to the sum of the numbers of innovativeness keywords and conservativeness keywords, the conservativeness degree being a ratio of the conservativeness keywords to the sum of the numbers of innovativeness keywords and conservativeness keywords. In the present embodiment, since the speech text of the guest includes an innovativeness keyword of “originality” and a conservativeness keyword of “famous”, the personality element index of the guest as a vector having the innovativeness degree of 0.5 and the conservativeness degree of 0.5, or a vector (0.5, 0.5) is computed. The personality element index is not limited to the above, but may be any other suitable element constituting personality, and may be an index represented by any other suitable representation such as a scalar quantity, a three or more-dimensional vector, and a matrix, or may be a numeral value not normalized.

The first personality model generation unit 111 generates a first personality model of the guest based on the computed emotion index and personality element index of the guest (S205). Specifically, in the present embodiment, a vector (0.6, 0.4, 0.5, 0.5) having the emotion index and the personality element index of the guest as its elements is generated as the first personality model. The first personality model is not limited to the above, but may be a model having any other suitable emotion index and personality element index as its elements, and may be an index represented by any other suitable representation such as a three or more-dimensional vector and a matrix.

The first personality model similarity computation unit 113 computes, respectively for a plurality of personality types, personality type similarities each of which is a similarity between the first personality model of the guest and the first personality model of the personality type (S207). Specifically, the personality type similarity is computed as below.

In the storage unit 131, the first personality model for each of the plurality of personality types is preset by the setting unit 133 through an input from the operator, and is stored in the first personality model table 503 of the personality type, as illustrated in FIG. 7. In the present embodiment, vectors having four elements of the emotion degree, the reason degree, the innovativeness degree, and the conservativeness degree for each of four personality types of ”leader,” “coordinator,” “specialist,” and “great supporter” are preset as the first personality model and stored in the storage unit 131, "leader" corresponding to a type of favoring a new matter or an innovative matter, having great communication skills, being challenging, and having large emotional ups and downs, “coordinator” corresponding to a type of being conservative, having great communication skills, being conformable, and being emotionally expressive, “specialist” corresponding to a type of favoring a new matter or an innovative matter and coolly and comprehensively making a decision, “great supporter” corresponding to a type of being conservative and cool, being scrupulous, and favoring stability (for example, a vector (1.0, 0.5, 1.0, 0.0) is for “leader”). The personality type is not limited to the above, but may be a type that represents any other suitable personality.

The first personality model similarity computation unit 113 calculates, for each of four personality types of “leader,” “coordinator,” “specialist,” and “great supporter”, an inner product of the vector representing the first personality model of the guest generated in step S205 and the vector representing the first personality model of each personality type to compute respective personality type similarities. In the present embodiment, the personality type similarities for four personality types of “leader,” “coordinator,” “specialist,” and “great supporter” are computed as 1.35, 1.2, 1.3, and 1.15, respectively.

The second personality model generation unit 115 generates a second personality model of the guest based on the personality type similarity based on the plurality of computed personality type similarities (S209). Specifically, in the present embodiment, a vector (1.35, 1.2, 1.3, 1.15) having the personality type similarities for four personality types of “leader,” “coordinator,” “specialist,” and “great supporter” as its elements is generated as the second personality model of the guest. The second personality model is not limited to the above, but may be a model based on a personality type similarity of any other suitable personality type, and may be an index represented by any other suitable representation such as a matrix.

### Preference Model Generation And Recommendation Item Determination Process

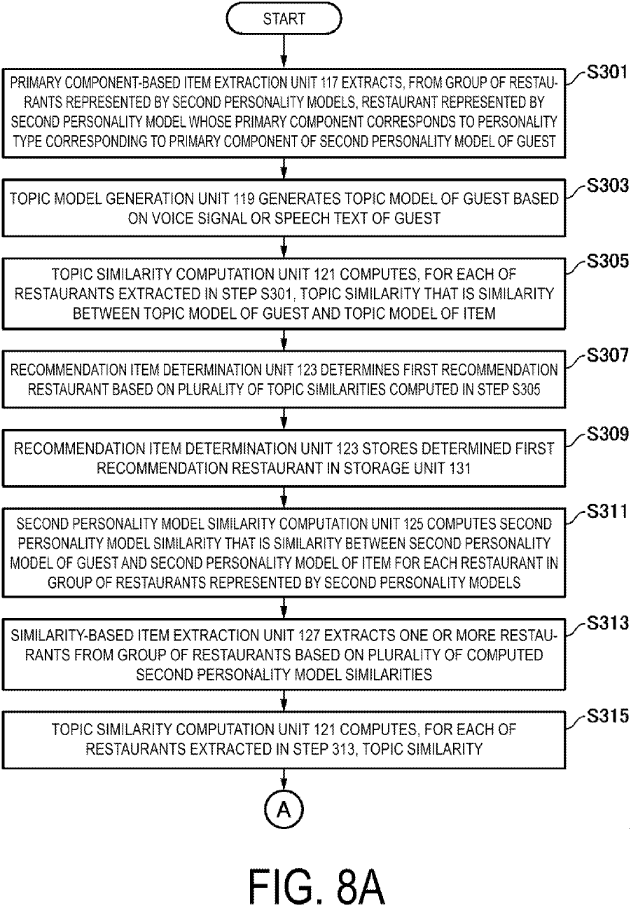

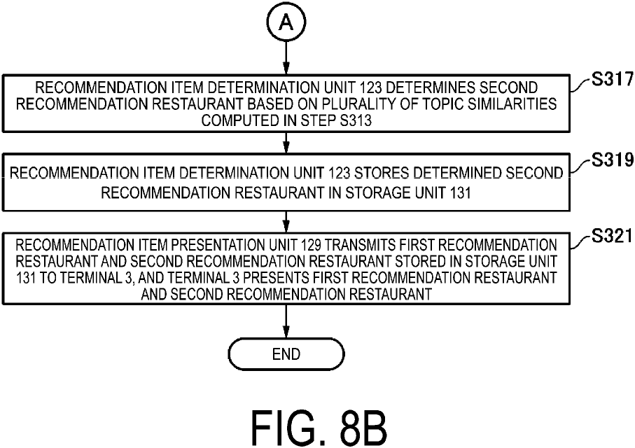

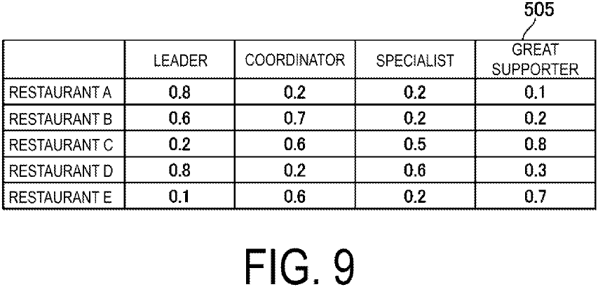

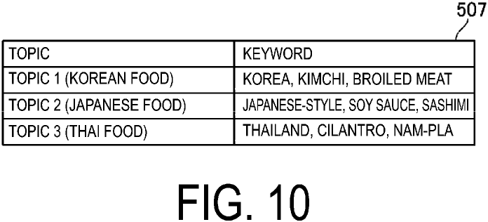

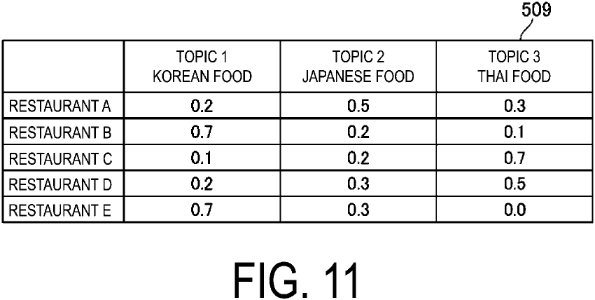

FIGS. 8A and 8B are flowcharts of an example of the preference model generation and recommendation item determination process according to the first embodiment of the present invention. FIG. 9 shows a second personality model table of a restaurant according to the first embodiment of the present invention. FIG. 10 shows a topic keyword list according to the first embodiment of the present invention. FIG. 11 shows a topic model table of a restaurant according to the first embodiment of the present invention.

The primary component-based item extraction unit 117 extracts, from a group of restaurants that is the group of items represented by the second personality models, a restaurant represented by the second personality model whose primary component corresponds to a personality type corresponding to a primary component of the second personality model of the guest generated in step S207 (S301). Specifically, the restaurant is extracted as below.

In the storage unit 131, the second personality model for each of restaurants A to E in the group of restaurants is preset by the setting unit 133 through an input from the operator, and is stored in the second personality model table 505 of the restaurant, as illustrated in FIG. 9. An element having the largest value of the elements of the vector of the second personality model of the guest generated in step S209 is the personality type similarity for “leader,” so that the personality type corresponding to the primary component of the second personality model of the guest is “leader.” The primary component-based item extraction unit 117 determines an element having the largest value of the elements of the vector of the second personality model of the guest generated in step S207, determines that the personality type corresponding to the element is a “leader”, and extracts, from the group of restaurants, a restaurant whose personality type similarity for “leader” is an element having the largest value. In the present embodiment, restaurants each of whose personality type similarity for “leader” is an element having the largest value, are the restaurant A and the restaurant D, so the primary component-based item extraction unit 117 extracts the restaurant A and the restaurant D.

The topic model generation unit 119 generates a topic model of the guest based on the voice signal or speech text of the guest (S303). The topic model is a model representing a relevance degree for each of a plurality of topics. Specifically, the topic model is generated as below.

In the present embodiment, a case that the topics are three topics of Korean food (topic 1), Japanese food (topic 2), and Thai food (topic 3) is described as an example.

In the storage unit 131, the topic keyword list 507 that is a list of topic keywords that are keywords for each topic is stored, as illustrated in FIG. 10. The topic model generation unit 119 refers to the topic keyword list 507 to count the number of topic keywords in the speech text of the guest for each topic, and generates, as a topic model of the guest, a vector having topic relevance degrees as its elements each of which is a ratio of each topic keyword to the sum of the numbers of respective topic keywords. The topic model is not limited to the above, but may be a model having any other suitable topic relevance degree as its elements, and may be an index represented by any other suitable representation such as a three or more-dimensional vector and a matrix. The topic relevance degree may be a numeral value not normalized.

In the present embodiment, in the speech text of the guest, there exist no topic keyword for Korean food, one topic keyword for Japanese food “Japanese-style”, and three topic keywords for Thai food “Thailand,” “cilantro,” and “nam-pla,” so the topic model generation unit 119 generates a vector (0, 0.25, 0.75) as a topic model of the guest.

The topic similarity computation unit 121 computes, for each of the restaurants extracted in step S301, a topic similarity that is a similarity between the topic model of the guest and the topic model of the item (S305). Specifically, the topic similarity is computed as below.

In the storage unit 131, the topic vector that is a topic model for each of the restaurants A to E in the group of restaurants is preset by the setting unit 133 through an input from the operator, and is stored in the topic model table 509 of the restaurant, as illustrated in FIG. 11. For example, for the restaurant A, a topic vector is (0.2, 0.5, 0.3), and the restaurant A is set to have a slightly larger relevance to the “Japanese food” of the topic 2, and have a slightly smaller relevance to the “Korean food” of the topic 1 and the “Thai food” of the topic 3. The topic similarity computation unit 121 calculates, for each of the restaurant A and the restaurant D extracted in step S301, an inner product of the topic vector of the guest generated in step S303 and the topic vector of the restaurant to compute respective corresponding topic similarities. In the present embodiment, the topic similarities are computed for the restaurant A and the restaurant D as 0.687 and 0.45, respectively.

The recommendation item determination unit 123 determines a first recommendation restaurant that is a first recommendation item based on the plurality of topic similarities computed in step S305 (S307). Specifically, predetermined number of n1 item(s) is(are) determined as the first recommendation restaurant(s) in descending order of the plurality of topic similarities computed in step S305. Note that the method for determining the first recommendation restaurant(s) is not limited to that based on the descending order of the plurality of topic similarities, but may be any other suitable method based on the plurality of topic similarities.

In the present embodiment, n1 = 2 holds, and the recommendation item determination unit 123 determines and stores in the storage unit 131 the restaurant A and the restaurant D in this order as the first recommendation restaurants (309).

The second personality model similarity computation unit 125 computes the second personality model similarity that is a similarity between the second personality model of the guest and the second personality model of the item for each restaurant in the group of restaurants represented by the second personality models (S311). Specifically, the second personality model similarity is computed as below.

As described above, in the storage unit 131, the second personality model for each of the restaurants A to E in the group of restaurants is preset, and is stored in the second personality model table 505 of the restaurant, as illustrated in FIG. 9. The second personality model similarity computation unit 125 calculates, for each of the restaurants A to E, an inner product of the vector that is the second personality model of the guest and the vector that is the second personality model of the restaurant to compute respective second personality model similarities. In the present embodiment, the second personality model similarities are computed for the restaurants A to E as 1.695, 2.14, 2.56, 2.445, and 1.92, respectively.

The similarity-based item extraction unit 127 extracts one or more restaurants from the group of restaurants that is the group of items based on the plurality of second personality model similarities computed in step S309 (S313). Specifically, in the present embodiment, the similarity-based item extraction unit 127 extracts predetermined m restaurant(s) in descending order of the second personality model similarities. In the present embodiment, m = 3 holds, and the restaurants are extracted in the order of the restaurant C, the restaurant D, and the restaurant B. Note that the method for extracting the restaurant is not limited to that based on the descending order of the second personality model similarities, but may be any other suitable method based on the second personality model similarity.

The topic similarity computation unit 121 computes, for each of the restaurants extracted in step 313, a topic similarity in the same way as in step S305 (S315). Specifically, the topic similarity computation unit 121 calculates, for each of the restaurant B, the restaurant C and the restaurant D extracted in step S313, an inner product of the topic vector of the guest and the topic vector of the restaurant to compute respective topic similarities. In the present embodiment, the topic similarities are computed for the restaurant B, the restaurant C, and the restaurant D as 0.125, 0.575, and 0.45, respectively.

The recommendation item determination unit 123 determines a second recommendation restaurant that is a second recommendation item based on the plurality of topic similarities computed in step S313 (S317). Specifically, the recommendation item determination unit 123 determines predetermined number n2 of restaurant(s) in descending order of the plurality of topic similarities computed in step S313 as the second recommendation restaurant(s) along with the presentation order of the second recommendation restaurant(s). Note that the method for determining the second recommendation restaurant(s) is not limited to that based on the descending order of the plurality of topic similarities, but may be any other suitable method based on the plurality of topic similarities.

The recommendation item determination unit 123 stores the determined second recommendation travel plan(s) in the storage unit 131 (S319). Specifically, in the present embodiment, n2=1 holds, and the recommendation item determination unit 123 determines and stores in the storage unit 131 the restaurant C as the second recommendation restaurant along with its presentation order.

The recommendation item output unit 129 transmits the first recommendation restaurant and the second recommendation restaurant stored in the storage unit 131 to the terminal 3, and the terminal 3 presents by display on the display, voice. or the like, the first recommendation restaurant and the second recommendation restaurant (S321). Specifically, the recommendation item output unit 129 transmits the first recommendation travel plan(s) and the presentation order of the first recommendation travel plan(s), and the second recommendation travel plan(s) and the presentation order of the second recommendation travel plan(s) stored in the storage unit 131 to the terminal 3, and the terminal 3 presents by display on the display, voice, or the like, the first recommendation travel plan(s) and the second recommendation travel plan(s) in the order of the first recommendation travel plan(s) and the second recommendation travel plan(s) in accordance with the presentation orders of the first and second recommendation travel plan(s). Note that the presentation order of the second recommendation travel plan(s) may not be determined or not stored in the storage unit 131, or the presentation order and the method for presentation may be any suitable ones in the presentation of the first recommendation travel plan(s) and the second recommendation travel plan(s). The output form of the recommendation item by recommendation item output unit 129 is not limited the above, but may be any other suitable form such as display on the display or voice from the speaker provided to the recommendation item determination system 1.

According to the present embodiment, the personality model (the first personality model) representing the user personality is generated using the emotion index of the user computed based on the voice signal of the user acquired from the conversation between the user and the conversational partner of the user, allowing the more accurate personality model to be generated.

In the present embodiment, the first personality models are set respectively for the plurality of personality types, the personality model similarities each of which is a similarity between the first personality model of the user and the first personality model of the personality type are computed, and the second personality model of the user based on the personality type similarity is generated based on the plurality of computed personality type similarities. Thus, the second personality model, which is based on the personality type similarity, is easy for a human to intuitively understand. Thus, according to the present embodiment, the first personality model that is a more accurate personality model can be converted into the second personality model that is a personality model easy for a human to intuitively understand, and provided.

In the present embodiment, the item recommendation is made using the second personality model based on the personality type similarity that is easy for a human to intuitively understand. Thus, according to the present embodiment, adjustment of the manner of the item recommendation can be facilitated by adjusting the respective values of the personality type similarities that are easy for a human to intuitively understand.

In the present embodiment, the first personality model based on the emotion index and the personality element index is converted into the second personality model based on the personality type similarity, and the item recommendation is made using the converted second personality model. Thus, according to the present embodiment, increasing the number of emotion indexes and personality element indexes making up the first personality model does not change the number of personality type similarities making up the second personality model if the number of personality types is not changed, and thus, the reason why the item is recommended can be grasped or the adjustment of the manner of the item recommendation can be made by use of the values of predetermined number of elements that are easy for a human to intuitively understand.

In the present embodiment, the recommendation item is determined based on the voice signal of the user acquired from the conversation between the user and the conversational partner of the user, the first personality models set respectively for the plurality of personality types, and the second personality models set respectively for the items in the group of items. Thus, according to the present embodiment, the accurate item recommendation can be made without accumulation of the user’s action history.

In the present embodiment, the item recommendation is made using the second personality model based on the plurality of personality type similarities, where not only the item recommendation based on the personality type similarities of the primary components of the second personality models set respectively for the items in the group of items, but also the item recommendation based on the plurality of personality type similarities of the second personality models. Thus, because not only the personality types corresponding to the personality type similarities of the primary components of the second personality models but also the item recommendation considering the values of the elements corresponding to the plurality of personality types are made, an item worth recommendation although not recommended in the conventional recommendation technique (that is the “restaurant C” in the present embodiment) can be recommended.

In the above embodiment, the inner product value is used for the similarity, but any other suitable measure such as cosine similarity, Pearson correlation, and distance can be used.

Although the above embodiment has the configuration in which the determined recommendation item is transmitted from the recommendation item determination system 1 to the terminal 3, some or all of the functions of the recommendation item determination system 1 can be included in the terminal 2.

### Second Embodiment

In the present embodiment, a case that a guest as a user asks a clerk for a travel plan recommendation at a counter of a travel agency is described as an example. A duplicate description for the first embodiment is omitted. An overall configuration, functional configuration, and hardware configuration of a recommendation item determination system according to a second embodiment are the same as those in the first embodiment, and thus descriptions thereof will be omitted.

### Voice Related Information Acquisition Process

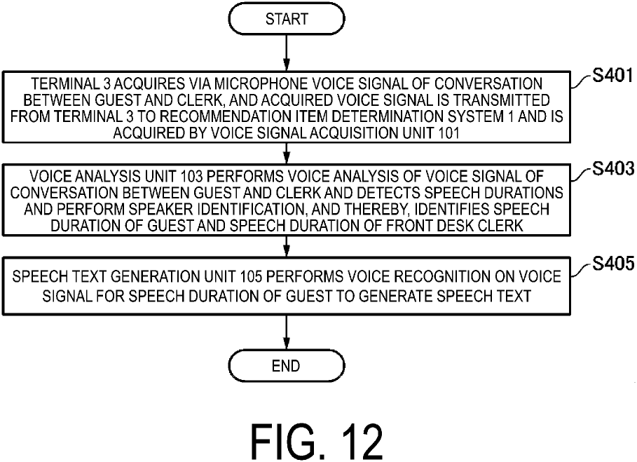

FIG. 12 is a flowchart illustrating an example of a voice related information acquisition process according to the second embodiment of the present invention.

The terminal 3 located at the counter of the travel agency acquires via a microphone (not illustrated) a voice signal of a conversation between the guest and the clerk, and the acquired voice signal is transmitted from the terminal 3 to the recommendation item determination system 1 and is acquired by the voice signal acquisition unit 101 (S401).

In the present embodiment, a case that the conversation between the guest and the clerk of the voice signal transmitted from the terminal 3 to the recommendation item determination system 1 is like the following is described as an example. Guest: I am looking for a domestic travel plan. Clerk: What kind of travel plan do you prefer? Guest: I am looking for a plan with some free time. However, I don’t have a driver’s license, so I prefer a plan to take a tour by train. Clerk: How many of you will go to travel? Guest: Not already decided, but I want to go to many places in a small group. Clerk: What kind of tourist spot do you want to go? Guest: I would love to go a novel spot not found in the Net if any. However, I also want to any famous spot.

The voice analysis unit 103 performs voice analysis of the voice signal of the conversation between the guest and the clerk acquired by the voice signal acquisition unit 101 and detects speech durations and perform a speaker identification, and thereby, identifies a speech duration of the user and a speech duration of the clerk (S403).

The speech text generation unit 105 performs voice recognition on the voice signal for the speech duration of the guest identified in S403 to generate a speech text (S405).

### Personality Model Generation Process

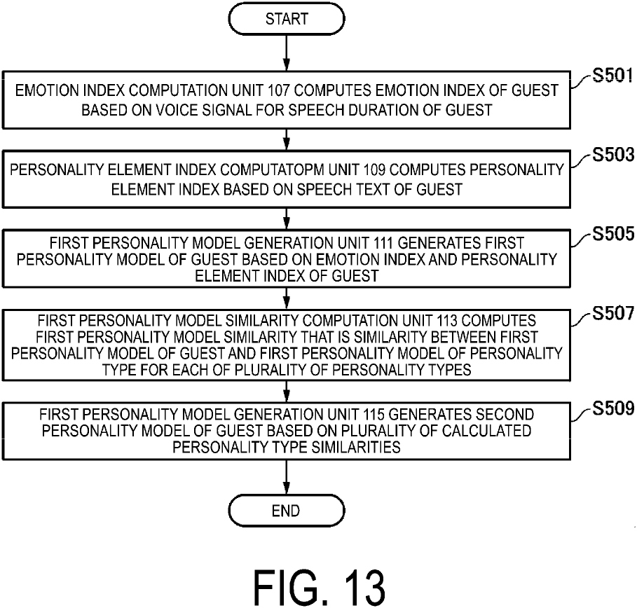

FIG. 13 is a flowchart of an example of a personality model generation process according to the second embodiment of the present invention.

The emotion index computation unit 107 computes an emotion index of the guest based on the voice signal for the speech duration of the guest identified in S403 (S501). In the present embodiment, based on the voice signal for the speech duration of the guest in the above conversation, an emotion index of the guest as a vector having the emotion degree of 0.6 and the reason degree of 0.4, or a vector (0.6, 0.4), is computed.

The personality element index computation unit 109 computes a personality element index based on the speech text of the guest generated in step S407 (S503). Specifically, the personality element index is computed as below. [0115] The personality element index computation unit 109 refers to the personality element keyword list 501 to count the number of innovativeness keywords and the number of conservativeness keywords in the speech text of the guest, and computes a vector having an innovativeness degree and a conservativeness degree as its elements, the innovativeness degree being a ratio of the innovativeness keywords to the sum of the numbers of innovativeness keywords and conservativeness keywords, the conservativeness degree being a ratio of the conservativeness keywords to the sum of the numbers of innovativeness keywords and conservativeness keywords. In the present embodiment, since the speech text of the guest includes an innovativeness keyword of “novel” and a conservativeness keyword of “famous”, the personality element index of the guest as a vector having the innovativeness degree of 0.5 and the conservativeness degree of 0.5, or a vector (0.5, 0.5) is computed.

The first personality model generation unit 111 generates a first personality model of the guest based on the computed emotion index and personality element index of the guest (S505). Specifically, in the present embodiment, a vector (0.6, 0.4, 0.5, 0.5) having the emotion index and the personality element index of the guest as its elements is generated as the first personality model.

The first personality model similarity computation unit 113 computes, respectively for a plurality of personality types, personality type similarities each of which is a similarity between the first personality model of the guest and the first personality model of the personality type (S507). Specifically, the personality type similarity is computed as below.

The first personality model similarity computation unit 113 calculates, for each of four personality types of “leader,” “coordinator,” “specialist,” and “great supporter”, an inner product of the vector representing the first personality model of the guest generated in step S505 and the vector representing the first personality model of each personality type to compute respective personality type similarities. In the present embodiment, the personality type similarities for four personality types of “leader,” “coordinator,” “specialist,” and “great supporter” are computed as 1.35, 1.2, 1.3, and 1.15, respectively.

The second personality model generation unit 115 generates a second personality model of the guest based on the personality type similarity based on the plurality of computed personality type similarities (S509). Specifically, in the present embodiment, a vector (1.35, 1.2, 1.3, 1.15) having the personality type similarities for four personality types of “leader,” “coordinator,” “specialist,” and “great supporter” as its elements is generated as the second personality model of the guest.

### Preference Model Generation And Recommendation Item Determination Process

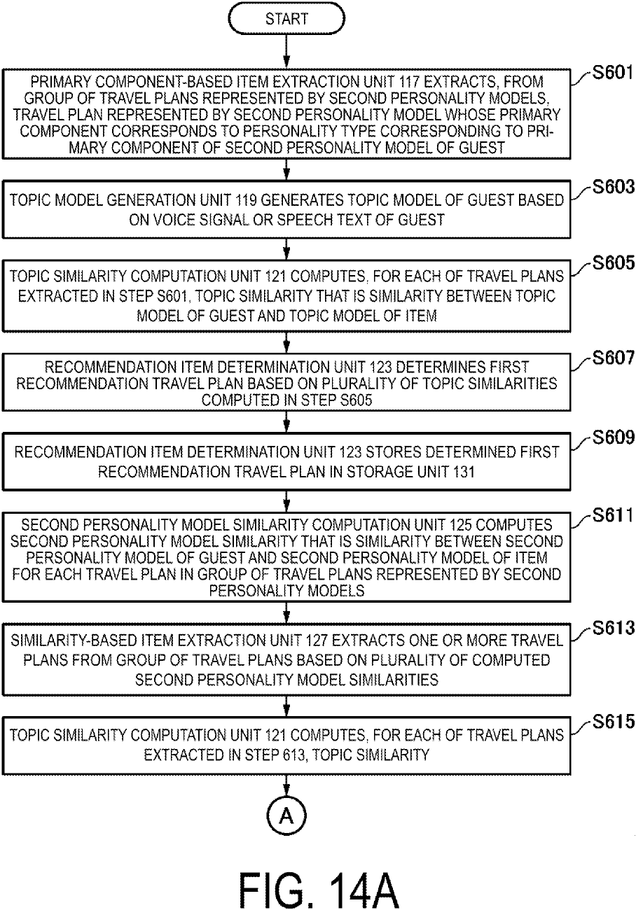

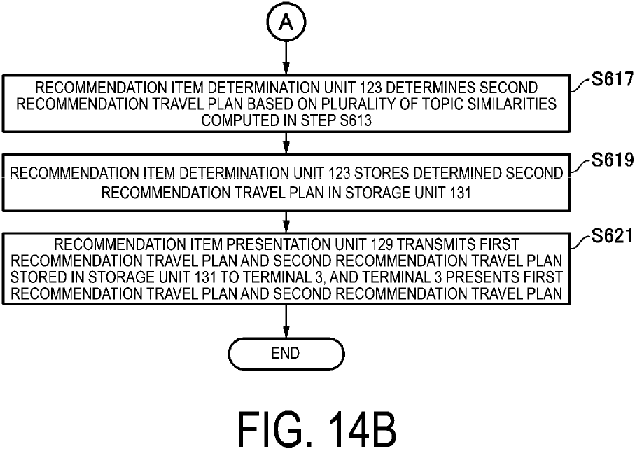

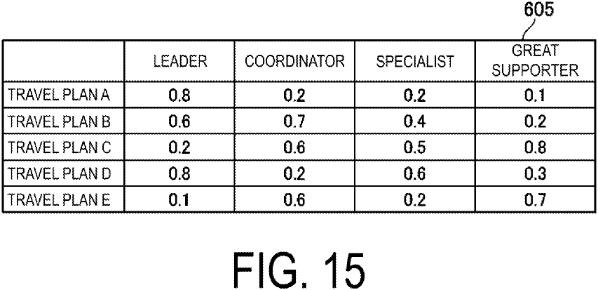

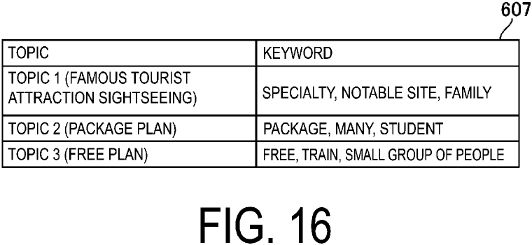

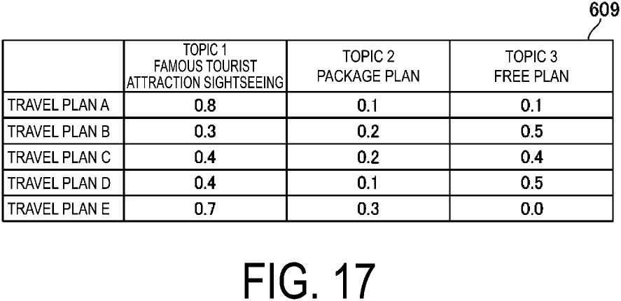

FIGS. 14A and 14B are flowcharts of an example of the preference model generation and recommendation item determination process according to the second embodiment of the present invention. FIG. 15 shows a second personality model table of a travel plan according to the second embodiment of the present invention. FIG. 16 shows a topic keyword list according to the second embodiment of the present invention. FIG. 17 shows a topic model table of a travel plan according to the second embodiment of the present invention.

The primary component-based item extraction unit 117 extracts, from a group of travel plans that is the group of items represented by the second personality models, a travel plan represented by the second personality model whose primary component corresponds to a personality type corresponding to a primary component of the second personality model of the guest generated in step S507 (S601). Specifically, the travel plan is extracted as below.

In the storage unit 131, the second personality model for each of travel plans A to E in the group of travel plans is preset, and is stored in the second personality model table 605 of the travel plan, as illustrated in FIG. 15. An element having the largest value of the elements of the vector of the second personality model of the guest generated in step S507 is the personality type similarity for “leader,” so that the personality type corresponding to the primary component of the second personality model of the guest is “leader.” The primary component-based item extraction unit 117 determines an element having the largest value of the elements of the vector of the second personality model of the guest generated in step S509, determines that the personality type corresponding to the element is a “leader”, and extracts, from the group of travel plans, a travel plan whose personality type similarity for “leader” is an element having the largest value. In the present embodiment, a travel planwhose personality type similarity for “leader” is an element having the largest value, is the travel plan A and the travel plan D, so the primary component-based item extraction unit 117 extracts the travel plan A and the travel plan D.

The topic model generation unit 119 generates a topic model of the guest based on the voice signal or speech text of the guest (S603). The topic model is a model representing a relevance degree for each of a plurality of topics. Specifically, the topic model is generated as below.

In the present embodiment, a case that the topics are three topics of famous tourist attraction sightseeing (topic 1), package plan (topic 2), and free plan (topic 3) is described as an example.

In the storage unit 131, the topic keyword list 607 that is a list of topic keywords that are keywords for each topic is stored, as illustrated in FIG. 16. The topic model generation unit 119 refers to the topic keyword list 607 to count the number of topic keywords in the speech text of the guest for each topic, and generates, as a topic model of the guest, a vector having as its elements topic relevance degrees each of which is a ratio of each topic keyword to the sum of the numbers of respective topic keywords.

In the present embodiment, in the speech text of the guest, there exist no topic keyword for famous tourist attraction sightseeing, one topic keyword for package plan “many”, and three topic keywords for free plan “free,” “train,” and “small group of people,” so the topic model generation unit 119 generates a vector (0, 0.25, 0.75) as a topic model of the guest.

The topic similarity computation unit 121 computes, for each of the travel plans extracted in step S601, a topic similarity that is a similarity between the topic model of the guest and the topic model of the item (S605). Specifically, the topic similarity is computed as below.

In the storage unit 131, the topic vector that is a topic model for each of the travel plans A to E in the group of travel plans is preset, and is stored in the topic model table 609 of the travel plan, as illustrated in FIG. 17. For example, for the travel plan A, a topic vector is (0.8, 0.1, 0.1), and the travel plan A is set to have a larger relevance to the “famous tourist attraction sightseeing” of the topic 1, and have a smaller relevance to the “package plan” of the topic 2 and the “free plan” of the topic 3. The topic similarity computation unit 121 calculates, for each of the travel plan A and the travel plan D extracted in step S601, an inner product of the topic vector of the guest generated in step S603 and the topic vector of the travel plan to compute respective corresponding topic similarities. In the present embodiment, the topic similarities are computed for the travel plan A and the travel plan D as 0.1 and 0.4, respectively.

The recommendation item determination unit 123 determines a first recommendation travel plan that is a first recommendation item based on the plurality of topic similarities computed in step S605 (S607). Specifically, predetermined number of n1 item(s) is(are) determined as the first recommendation travel plan(s) in descending order of the plurality of topic similarities computed in step S605.

In the present embodiment, n1 = 2 holds, and the recommendation item determination unit 123 determines and stores in the storage unit 131 the travel plan A and the travel plan D in this order as the first recommendation travel plans (S609).

The second personality model similarity computation unit 125 computes a second personality model similarity that is a similarity between the second personality model of the guest and the second personality model of the item for each item in the group of travel plans represented by the second personality models (S611). Specifically, the second personality model similarity is computed as below.

As describe above, in the storage unit 131, the second personality model for each of the travel plans A to E in the group of travel plans is preset by the setting unit 133 through an input from the operator, and is stored in the second personality model table 505 of the travel plan, as illustrated in FIG. 15. The second personality model similarity computation unit 125 calculates, for each of the travel plans A to E, an inner product of the vector that is the second personality model of the guest and the vector that is the second personality model of the travel plan to compute respective second personality model similarities. In the present embodiment, the second personality model similarities are computed for the travel plans A to E as 1.695, 2.792, 2.56, 2.445, and 1.92, respectively.

The similarity-based item extraction unit 127 extracts one or more travel plans from the group of travel plans that is the group of items based on the plurality of second personality model similarities computed in step S609 (S613). Specifically, in the present embodiment, the similarity-based item extraction unit 127 extracts predetermined m travel plans in descending order of the second personality model similarities. In the present embodiment, m = 3 holds, and the travel plans are extracted in the order of the travel plan B, the travel plan C, and the travel plan D.

The topic similarity computation unit 121 computes, for each of the travel plans extracted in step 313, a topic similarity in the same way as in step S605 (S615). Specifically, the topic similarity computation unit 121 calculates, for each of the travel plan B, the travel plan C, and the travel plan D extracted in step S313, an inner product of the topic vector of the guest and the topic vector of the travel plan to compute respective topic similarities. In the present embodiment, the topic similarities are computed for the travel plan B, the travel plan C, and the travel plan D as 0.425, 0.35, and 0.4, respectively.

The recommendation item determination unit 123 determines a second recommendation travel plan that is a second recommendation item based on the plurality of topic similarities computed in step S613 (S617). Specifically, the recommendation item determination unit 123 determines predetermined number n2 of travel plan(s) in descending order of the plurality of topic similarities computed in step S613 as the second recommendation travel plan(s) along with the presentation order of the second recommendation travel plan(s).

The recommendation item determination unit 123 stores the determined second recommendation travel plan in the storage unit 131 (S619). Specifically, in the present embodiment, n2=1 holds, and the recommendation item determination unit 123 determines and stores in the storage unit 131 the travel plan B as the second recommendation travel plan along with its presentation order.

The recommendation item output unit 129 transmits the first recommendation travel plan and the second recommendation travel plan stored in the storage unit 131 to the terminal 3, and the terminal 3 presents by display on the display, voice, or the like, the first recommendation travel plan and the second recommendation travel plan (S621).

According to the present embodiment, the same effect as the first embodiment described above can be obtained. Particularly, the point is described below that the adjustment of the manner of the item recommendation can be facilitated by adjusting the respective values of the personality type similarities that are easy for a human to intuitively understand.

The travel plan B includes, in an entire schedule, several days of visiting tourist attractions and several days of free time. Considering a case that the travel agency makes a campaign of a travel plan that includes a free time schedule, the first personality model based on data acquired by a machine is converted into the second personality model having the elements as the personality type similarities that are easy for a human to intuitively understand, and thus, adjustment can be made for the second personality model of the travel plan B such that the personality type similarities increase for the leader and the specialist which are the personality types considered to prefer the free time schedule to easily present the travel plan B as a recommendation travel plan having a high presentation order to the user with the large value of the personality type similarity for the leader and the user with the large value of the personality type similarity for the specialist.

Consider, for example, a case that in the second personality model of the travel plan B, the personality type similarity for the leader is changed from 0.6 to 0.8 and the personality type similarity for the specialist is changed from 0.4 to 0.5. In this case, for example, a clerk in headquarters of the travel agency selects the personality type similarities for “leader” and “specialist” from the personality type similarities of the second personality model of the travel plan B which are displayed on a display of a terminal (not illustrated) connected to the recommendation item determination system 1 via the network 2 and located at the headquarters of the travel agency, inputs change of the value of the personality type similarity for “leader” from 0.6 to 0.8 and change of the value of the personality type similarity for “specialist” from 0.4 to 0.5. The input is transmitted from the terminal to the recommendation item determination system 1, and the setting unit 133 updates the personality type similarities from 0.6 to 0.8 and from 0.4 to 0.5, respectively, for “leader” and “specialist” of the second personality model of the travel plan B stored in the second personality model table for the group of travel plans in the storage unit 131. In this case, an element having the largest value of the elements of the vector of the second personality model of the guest as the user is the personality type similarity for “leader,” so that the personality type corresponding to the primary component of the second personality model of the guest is “leader.” This change in the personality type similarities of the leader and the specialist causes the travel plan B also to become a travel plan whose personality type similarity for “leader” is the element having the largest value, and thus, in step S601, the travel plan B is extracted as a candidate for the first recommenddation travel plan along with the travel plan A and the travel plan D by the primary component-based item extraction unit 117. Then, the topic similarities for the travel plan A, the travel plan B, and the travel plan D are computed as 0.1, 0.425, and 0.4, respectively, by the topic similarity computation unit 121 in step S605, the travel plan B and the travel plan D are determined as the first recommendation travel plan in descending order of the topic similarities from among the travel plan A, the travel plan B, and travel plan D by the recommendation item determination unit 123 in step S607, and the travel plan B is presented to the user with the first presentation order by the recommendation item output unit 129 in step S621.

Hereinabove, some embodiments of the present invention have been described for purposes of illustration, but it will be apparent to those skilled in the art that the present invention is not to the embodiments and that various variations and modifications can be made in forms and details without departing from the scope and spirit of the present invention.

### REFERENCE SIGNS LIST

1 Recommendation item determination system
101 Voice signal acquisition unit
103 Voice analysis unit
105 Speech text generation unit
107 Emotion index computation unit
109 Personality element index computation unit
111 First personality model generation unit
113 First personality model similarity computation unit
115 Second personality model generation unit
117 Primary component-based item extraction unit
119 Topic model generation unit
121 Topic similarity generation unit
123 Recommendation item determination unit
125 Second personality model similarity computation unit
127 Similarity-based item extraction unit
129 Recommendation item output unit
131 Storage unit
10a CPU
10b RAM
10c ROM
10d External memory
10e Input unit
10f Output unit
10g Communication unit
10h System bus
2 Network
3 Terminal
501 Personality element keyword list
503 First personality model table of personality type
505 Second personality model table of group of restaurants
507 Topic keyword list
509 Topic model table of group of restaurants
605 Second personality model table of group of travel plans
607 Topic keyword list
609 Topic model table of group of travel plans

Claim 1. A recommendation item determination system comprising:
at least one processor;
at least one storage; and
program instructions stored in the at least one storage and executable by the at least one processor to carry out operations including:
computing an emotion index of a user based on a voice signal acquired from a conversation between the user and a conversational partner of the user;
computing a personality element index based on a speech text generated by voice recognition on the voice signal of the user;
generating, based on the emotion index and the personality element index, a first personality model of the user based on an emotion index and a personality element index;
computing, respectively for a plurality of personality types, personality type similarities each of which is a similarity between the first personality model of the user and the first personality model of the personality type;
generating, based on the plurality of personality type similarities, a second personality model of the user based on a personality type similarity;
extracting one or more items from a group of items represented by the second personality model; and
determining a recommendation item based on the extracted one or more items.

Claim 2. The recommendation item determination system according to claim 1, wherein the operations further including:
setting and/or changing a value of the emotion index and/or the personality element index of the first personality model of at least one personality type of the plurality of personality types, and/or at least one of personality type similarities of the second personality type of at least one item of the group of items.

Claim 3. The recommendation item determination system according to claim 1, wherein the operations further including:
generating a topic model of the user representing a relevance degree for each of a plurality of topics based on the voice signal of the user or the speech text of the user; and
computing, for each of the extracted items, a topic similarity that is a similarity between a topic model of the user and a topic model of the item,
wherein the determining a recommendation item based on the extracted one or more items comprises determining a recommendation item based on the plurality of computed topic similarities.

Claim 4. The recommendation item determination system according to claim 2, wherein the operations further including:
generating a topic model of the user representing a relevance degree for each of a plurality of topics based on the voice signal of the user or the speech text of the user; and
computing, for each of the extracted items, a topic similarity that is a similarity between a topic model of the user and a topic model of the item,
wherein the operation further including setting and/or changing a value of at least one of elements of the topic model of the items.

Claim 5. The recommendation item determination system according to claim 1, wherein the extracting one or more items from a group of items represented by the second personality model comprising extracting, from a group of items represented by the second personality models, an item represented by the second personality model whose primary component corresponds to a personality type corresponding to a primary component of the second personality model of the user.

Claim 6. The recommendation item determination system according to claim 1, wherein the operations further
including computing a second personality model similarity that is a similarity between the second personality model of the user and the second personality model of the item for each item in the group of items represented by the second personality models,
wherein the extracting one or more items from a group of items represented by the second personality model comprising extracting one or more items from the group of items based on the plurality of computed second personality model similarities.

Claim 7. The recommendation item determination system according to claim 1, wherein the operations further including:
generating a topic model of the user representing a relevance degree for each of a plurality of topics based on the voice signal of the user or the speech text of the user,
extracting, from the group of items represented by the second personality models, the item represented by the second personality model whose primary component corresponds to a personality type corresponding to a primary component of the second personality model of the user,
computing, for each of the extracted items, a topic similarity that is a similarity between a topic model of the user and a topic model of the item,
determining a first recomendation item based on the computed topic similarity,
computing a second personality model similarity that is a similarity between the second personality model of the user and the second personality model of the item for each item in the group of items represented by the second personality models,
extracting one or more items from the group of items based on the computed second personality model similarities,
computing, for each of the extracted items, a topic similarity that is a similarity between a topic model of the user and a topic model of the item,
determining the second recommendation based on the comuted topic similarity,
determining the first recommendation item and the second recommendation item as recommendation items.

Claim 8. The recommendation item determination system according to claim 1, wherein the emotion index includes an emotion degree and a reason degree.

Claim 9. The recommendation item determination system according to claim 1, wherein the personality element index includes an innovativeness degree and a conservativeness degree.

Claim 10. The recommendation item determination system according to claim 1, wherein the first and/or second personality model is represented by a vector.

Claim 11. The recommendation item determination system according to claim 1, wherein the second personality model has elements of an emotion degree, a reason degree, an innovativeness degree, and a conservativeness degree.

Claim 12. The recommendation item determination system according to claim 1, wherein the plurality of personality types includes a type of favoring a new matter or an innovative matter, having great communication skills, being challenging, and having large emotional ups and downs, a type of being conservative, having great communication skills, being conformable, and being emotionally expressive, a type of favoring a new matter or an innovative matter and coolly and comprehensively making a decision, and a type of being conservative and cool, being scrupulous, and favoring stability.

Claim 13. The recommendation item determination system of claims 1, wherein the topic vector of the user has an element of a numerical value based on the number of times at which at least one keyword preset for each topic appears in the speech text.

Claim 14. A personality model generation system comprising:
at least one processor;
at least one storage; and
program instructions stored in the at least one storage and executable by the at least one processor to carry out operations including:
computing an emotion index of a user based on a voice signal acquired from a conversation between the user and a conversational partner of the user;
computing a personality element index based on a speech text generated by voice recognition on the voice signal of the user;
generating, based on an emotion index and a personality element index, a first personality model of the user based on an emotion index and a personality element index;
computing, respectively for a plurality of personality types, personality type similarities each of which is a similarity between the first personality model of the user and the first personality model of the personality type; and
generating, based on the plurality of personality type similarities, a second personality model of the user based on a personality type similarity.

Claim 15. The personality model generation system according to claim 14, wherein the operations further including:
setting and/or changing a value of the emotion index and/or the personality element index of the first personality model of at least one personality type of the plurality of personality types, and/or at least one of personality type similarities of the second personality type of at least one item of the group of items.

Claim 16. (canceled)

Claim 17. A recommendation item determination method executed by a computer, the method comprising:
computing an emotion index of a user based on a voice signal acquired from a conversation between the user and a conversational partner of the user;
computing a personality element index based on a speech text generated by voice recognition on the voice signal of the user;
generating, based on the emotion index and the personality element index, a first personality model of the user based on an emotion index and a personality element index;
computing, respectively for a plurality of personality types, personality type similarities each of which is a similarity between the first personality model of the user and the first personality model of the personality type;
generating, based on the plurality of personality type similarities, a second personality model of the user based on a personality type similarity;
extracting one or more items from a group of items represented by the second personality model; and
determining a recommendation item based on the extracted one or more items.

Claim 18. A non-transitory computer-readable recording medium having thereon a program causing a computer to execute the method according to claim 17.

Claim 19.

Claim 20. A method of generating a recommendation item determination system by installing a program on the computer causing a computer to execute the method according to claim 17.

Claim 21. A personality model generation method executed by a computer, the method comprising:
computing an emotion index of a user based on a voice signal acquired from a conversation between the user and a conversational partner of the user;
computing a personality lement index based on a speech text generated by voice recognition on the voice signal of the user;
generating, based on an emotion index and a personality element index, a first personality model of the user based on an emotion index and a personality element index;
computing, respectively for a plurality of personality types, personality type similarities each of which is a similarity between the first personality model of the user and the first personality model of the personality type; and
generating, based on the plurality of personality type similarities, a second personality model of the user based on a personality type similarity.

Claim 22. A non-transitory computer-readable recording medium having recorded thereon a program causing a computer to execute the method according to claim 21.

Claim 23. A method of generating a personality model generation system by installing on the computer a program causing a computer to execute the method according to claim 21.
